(19) United States
(12) Patent Application Publication
(10) Pub. No.: US 2011/0188837 A1
(43) Pub. Date: Aug. 4, 2011

(54) Electronic Apparatus, Motion Picture Playback System, and Motion Picture Playback Method

(76) Inventors: Ryosuke Hiramatsu, Fujisawa-shi (JP); Kozo Taira, Machida-shi (JP); Shinji Yamadaji, Tachikawa-shi (JP)

(21) Appl. No.: 13/006,190

(22) Filed: Jan. 13, 2011

(30) Foreign Application Priority Data
Jan. 29, 2010 (JP) 2010-019699

(51) Int. Cl. H04N 5/60; H04N 5/78

(52) U.S. Cl. 386/314; 348/738; 348/E05.122; 386/E05.003

(57) ABSTRACT

According to one embodiment, an electronic apparatus includes a receiving module, a receiving module and a sound output module. The receiving module is configured to receive data of a motion picture and data of sound associated with a given timing in the motion picture, the data of the sound generated separately from the motion picture. The receiving module is configured to play back the motion picture. The sound output module is configured to output the sound at the given timing when the motion picture playing back module plays back the motion picture.

### CROSS REFERENCE TO RELATED APPLICATION(S)

This application is based upon and claims the benefit of priority from Japanese Patent Application No. 2010-19699 filed on Jan. 29, 2010, the entire contents of which are incorporated herein by reference.

### BACKGROUND

1. Field

Embodiments described herein relate generally to an electronic apparatus, a motion picture playback system, and a motion picture playback method which can output voices together with a content.

2. Description of the Related Art

With the recent development of communications technologies, the form in which a provider provides a motion picture content (motion picture information of a motion picture that can be played back by an electronic apparatus having a motion picture playback function) to a user has been diversified. Content providers are trying to provide users with the motion picture content having new added value.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary schematic view showing a motion picture providing system according to an embodiment;

FIG. 2 is an exemplary block diagram showing an internal configuration of a DTV according to the embodiment;

FIG. 3 is an exemplary block diagram showing an internal configuration of a server according to the embodiment;

FIG. 4 is an exemplary view showing data structure of a motion picture content according to the embodiment;

FIG. 5 is an exemplary view showing a detailed data structure of a user voice information according to the embodiment;

FIG. 6 is an exemplary block diagram showing a functional configuration, relating to a playback process for playing back a motion picture and user voices of a motion picture content, of the DTV according to the embodiment;

FIG. 7 is an exemplary schematic view of the DTV on which an account name display image is displayed according to the embodiment;

FIG. 8 is an exemplary flowchart showing a process for playing back a motion picture content which is executed by the DTV according to the embodiment; and

FIG. 9 is an exemplary flowchart showing a process for transmitting to the server the user voices that are picked up by the DTV according to the embodiment.

### DETAILED DESCRIPTION

In general, according to one embodiment, an electronic apparatus includes a receiving module, a receiving module and a sound output module. The receiving module is configured to receive data of a motion picture and data of sound associated with a given timing in the motion picture, the data of the sound generated separately from the motion picture. The receiving module is configured to play back the motion picture. The sound output module is configured to output the sound at the given timing when the motion picture playing back module plays back the motion picture.

An exemplary embodiment of the present invention will be hereinafter described with reference to the drawings.

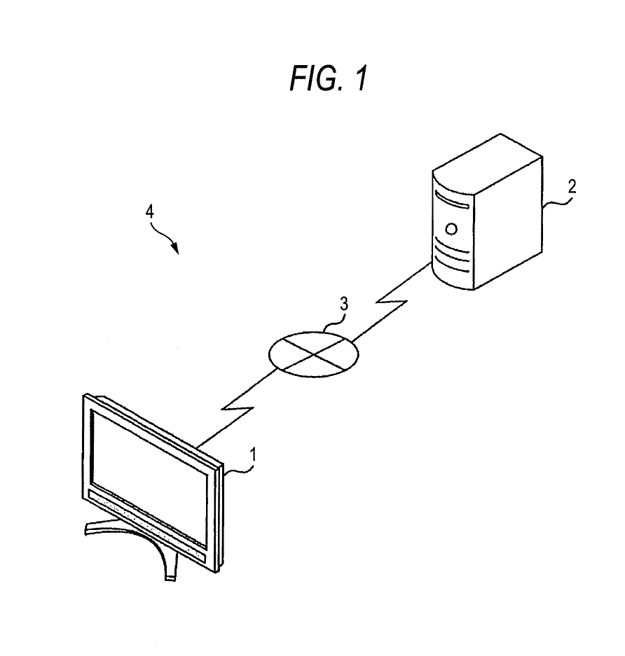

FIG. 1 is an exemplary schematic view of a motion picture providing system 4 according to the embodiment.

A digital TV receiver (DTV) 1 (example electronic apparatus) according to the embodiment has a function of extracting audio-video information from a broadcast signal of received broadcast waves and outputting it. The DTV 1 is connected to a network 3 so as to be able to communicate with it. Although the DTV 1 is shown as an electronic apparatus according to the invention, the electronic apparatus may be any of other various apparatus including a set-top box (STB) and various recorders such as an HDD (hard disk drive) recorder, and a DVD (digital versatile disc) recorder.

A server 2 records, as motion pictures, pieces of audio-video information of broadcast programs that are broadcast from TV broadcasting stations, and stores motion picture contents each of which is a combination of the recorded motion picture, information relating to the motion picture program, and voices that are transmitted from a user. Connected to the network 3, the server 2 can communicate with an electronic apparatus connected to the network 3.

The network 3, which is a wide area network (WAN) such as the Internet, allows apparatus connected to it to communicate with each other.

In the motion picture providing system 4, the DTV 1 can receive a motion picture content from the server 2 and play back its motion picture. The DTV 1 records voices that the user utters while a motion picture is being played back and transmits the recorded user voices to the server 2. The server 2 stores the received user voices, and transmits, to another electronic apparatus that is going to receive the same motion picture, a motion picture content that includes the motion picture and the user voices. Thus, the other electronic apparatus can output the user voices during playback of the motion picture.

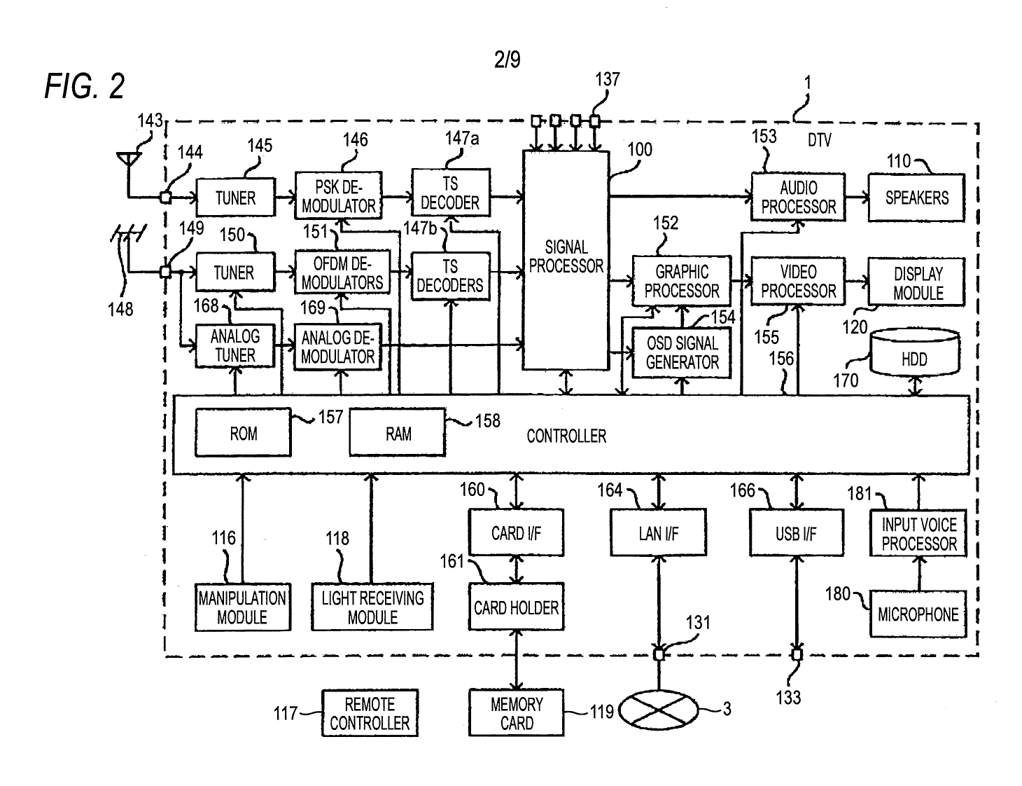

First, an internal configuration of the DTV 1 will be described. FIG. 2 is an exemplary block diagram showing the internal configuration of the DTV 1 according to the embodiment.

The DTV 1 is equipped with a controller 156 for controlling operations of the individual components of the apparatus. The controller 156 incorporates a CPU (central processing unit) etc. The controller 156 activates a system control program and various processing programs stored in a ROM (read-only memory) 157 in advance in response to a manipulation signal that is input through a manipulation module 116 or transmitted from a remote controller 117 and received by a light receiving module 118. The controller 156 controls operations of the individual components of the apparatus according to the activated programs using a RAM (random access memory) 158 as a work memory.

Satellite digital TV broadcast signals received by a BS/CS digital broadcast receiving antenna 143 are supplied to a satellite digital broadcast tuner 145 via an input terminal 144. The tuner 145 tunes in to one of the received digital broadcast signals and supplies the thus-selected digital broadcast signal to a PSK (phase shift keying) demodulator 146. The PSK demodulator 146 demodulates the digital broadcast signal into a transport stream (TS) and supplies the transport stream to a TS decoder 147a. The TS decoder 147a decodes the transport stream into a digital signal containing a digital video signal, a digital audio signal, and a data signal and outputs it to a signal processor 100. The digital video signal is a video-related digital signal that can be output by the DTV 1, and the digital audio signal is an audio-related digital signal that can be output by the DTV 1. The data signal is a digital signal that represents information relating to broadcast programs and contains, for example, program-related information which is information to be used when the DTV 1 generates an electronic program guide (EPG). The program-related information contains a title, detailed information, a program start time, a program end time, etc. of each broadcast program.

Terrestrial digital TV broadcast signals received by a terrestrial digital broadcast receiving antenna 148 are supplied to a terrestrial digital broadcast tuner 150 via an input terminal 149. The tuner 150 tunes in to part of the received digital broadcast signals and supplies the thus-selected digital broadcast signals to respective OFDM (orthogonal frequency division multiplexing) demodulators 151. The OFDM demodulators 151 demodulate the digital broadcast signals into transport streams and supplies the transport streams to respective TS decoders 147b. The TS decoders 147b decode the transport streams into digital video signals, digital audio signals, etc. and output those signals to the signal processor 100. Terrestrial digital broadcast signals selected by eleven tuners of the tuner 150 can be converted simultaneously by the multiple OFDM demodulators 151 and the multiple TS decoders 147b into digital signals containing digital video signals, digital audio signals, and data signals, respectively, which are output to the signal processor 100.

The antenna 148 can also receive terrestrial analog TV broadcast signals. The received terrestrial analog broadcast signals are distributed by a distributor (not shown) and supplied to an analog tuner 168. The analog tuner 168 tunes in to one of the received analog broadcast signals and supplies the thus-selected analog broadcast signal to an analog demodulator 169. The analog demodulator 169 demodulates the analog broadcast signal and outputs a resulting analog broadcast signal to the signal processor 100. If, for example, a CATV (Common Antenna Television) tuner is connected to the input terminal 149 to which the antenna 148 is connected, the DTV 1 allows the user to view CATV broadcast programs.

The signal processor 100 performs proper signal processing on a digital signal that is output from the TS decoder 147a, each TS decoder 147b, or the controller 156. More specifically, the signal processor 100 separates the digital signal into a digital video signal, a digital audio signal, and a data signal. The separated video signal and audio signal are output to a graphic processor 152 and an audio processor 153, respectively. Furthermore, the signal processor 100 converts a broadcast signal that is output from the analog demodulator 169 into a video signal and an audio signal having prescribed digital formats. Those digital video signal and audio signal are output to the graphic processor 152 and the audio processor 153, respectively. Still further, the signal processor 100 performs prescribed digital signal processing on an input signal that is supplied via a line input terminal 137.

An OSD (on-screen display) signal generator 154 generates, under the control of the controller 156, an OSD signal for display of a UI (user interface) picture or the like. A data signal that is separated from a digital signal by the signal processor 100 is converted by the OSD signal generator 154 into an OSD signal having a proper format, which is output to the graphic processor 152.

The graphic processor 152 decodes a digital video signal that is output from the signal processor 100. A decoded video signal is combined with (superimposed on) an OSD signal that is output from the OSD signal generator 154, and a resulting signal is output to the video processor 155. The graphic processor 152 can also select and output the decoded video signal or the OSD signal to the video processor 155.

The video processor 155 converts an output signal of the graphic processor 152 into an analog video signal having such a format as to be displayable by a display module 120. The analog video signal is thus displayed on the display module 120.

The audio processor 153 converts a received audio signal into an analog audio signal having such a format as to be played back by speakers 110. The analog audio signal is thus output to and played back by the speakers 110.

A card holder 161 is connected to the controller 156 via a card interface (I/F) 160. A memory card 119 can be inserted into the card holder 161. The memory card 119 is a storage medium such as an SD (secure digital) memory card, an MMC (multimedia card), or a CF (compact flash) card. The controller 156 can perform information writing and reading via the card I/F 160 on the memory card 119 that is inserted in the card holder 161.

A LAN terminal 131 is connected to the controller 156 via a LAN I/F 164. The LAN terminal 131 is used as a general LAN-compatible port that complies with Ethernet. In the embodiment, a LAN cable is connected to the LAN terminal 131, whereby the controller 156 can communicate with the network 3.

A USB (universal serial bus) terminal 133 is connected to the controller 156 via a USB I/F 166. The USB terminal 133 is used as a general USB-compatible port. A celler phone, a digital camera, a card reader/writer for any of various memory cards, an HDD, a keyboard, etc. are connected to the USB terminal 133 via a hub, for example. The controller 156 can communicate (exchange information) with each device that is connected to the USB terminal 133.

An HDD 170, which is a magnetic storage medium incorporated in the DTV 1, has a function of storing various kinds of information to be held by the DTV 1.

A microphone 180 has a function of converting an input voice into an electrical signal and inputting the electrical signal to the DTV 1.

An input voice processor 181 has a function of performing proper signal processing on the electrical signal that is input from the microphone 180 and inputting a resulting signal to the controller 156.

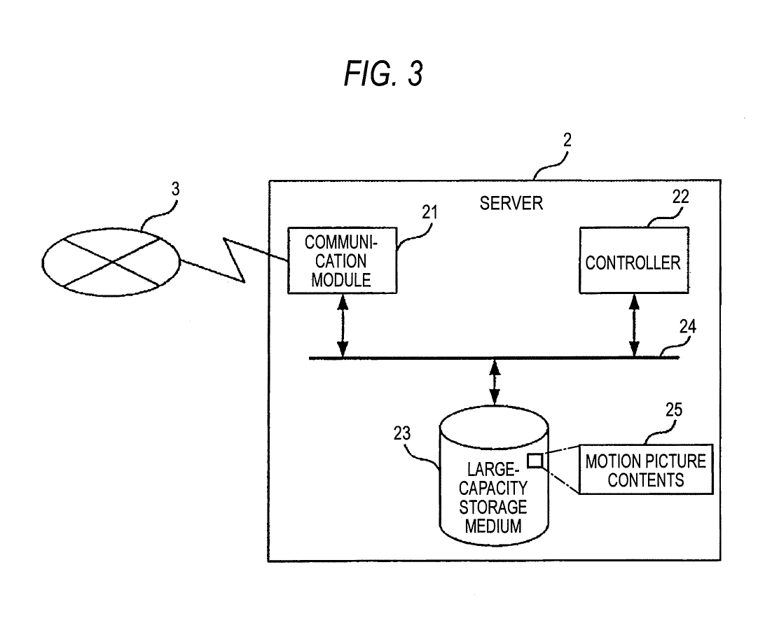

Next, an internal configuration of the server 2 will be described. FIG. 3 is an exemplary block diagram showing the internal configuration of the server 2 according to the embodiment.

As shown in FIG. 3, the server 2 includes a communication module 21, a controller 22, and a large-capacity storage medium 23 which are connected to the communication module 21 and the controller 22 via a bus 24. The large-capacity storage medium 23 is stored with motion picture contents 25.

Connected to the network 3, the communication module 21 has a function of communicating with the network 3.

The controller 22 has a function of controlling the entire server 2. When receiving, from the DTV 1, via the communication module 21, a request for transmitting a motion picture content that is stored in the large-capacity storage medium 23, the controller 22 transmits the requested motion picture content to the DTV 1. When receiving user voices from the DTV 1, the controller 22 stores them in the large-capacity storage medium 23 in such a manner that they are contained in a corresponding motion picture content.

The large-capacity storage medium 23 is a large-capacity nonvolatile storage medium such as a magnetic storage medium and is stored with multiple motion picture contents.

The bus 24 has a bus function of allowing communication between the components connected to it.

As described above, each motion picture content 25 is data containing a recorded program (motion picture), related information which is information relating to the recorded program, and user voices that were transmitted from a user. When receiving a motion picture content 25, the DTV 1 can output the motion picture of the recorded program and the user voices that are contained in the motion picture content 25.

Next, various kinds of information to be recorded as parts of a motion picture content 25 will be described.

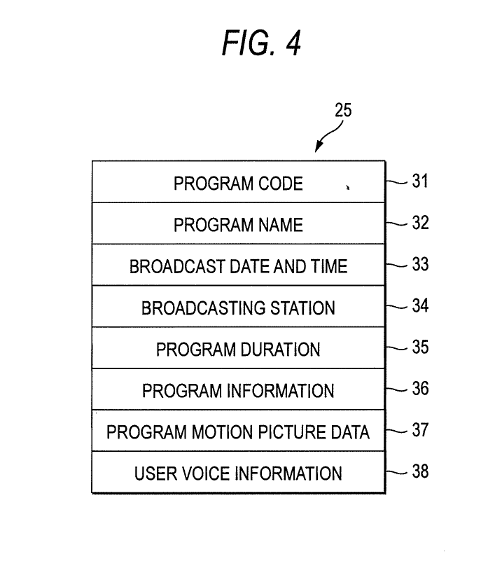

FIG. 4 shows an exemplary data structure of a motion picture content 25 according to the embodiment. As shown in FIG. 4, the motion picture content 25 consists of a program code 31, a program name 32, a broadcast date and time 33, a broadcasting station 34, a program duration 35, program information 36, program motion picture data 37, and user voice information 38.

The program code 31 is an identification code that is assigned to the recorded program of the motion picture content 25. The program name 32 is a program name of the recorded program of the motion picture content 25. The broadcast date and time 33 is information of a broadcast date and time of the recorded program of the motion picture content 25. The broadcasting station 34 is information of a broadcasting station that broadcast the recorded program of the motion picture content 25. The broadcast duration 35 is information of a broadcasting duration of the entire recorded program of the motion picture content 25.

The program information 36 includes keywords relating to the recorded program of the motion picture content 25. Example keywords are a program genre and the names of persons who appear in the recorded program.

When the user of the DTV 1 searches the server 2 for a desired motion picture content, that is, a motion picture content the user wants to play back, its program code 31 to program information 36 can be used.

The program motion picture data 37 is audio-video data of the recorded program of the motion picture content 25. The user voice information 38 is user voice data that were received from an electronic apparatus and information relating to the user voices and was generated separately from the program motion picture data 37. Specifically, the user voice data are voice data of ambient sound that were picked up by the microphone 180 of the electronic apparatus when the electronic apparatus played back the motion picture content 25 and is supposed to include the user voice.

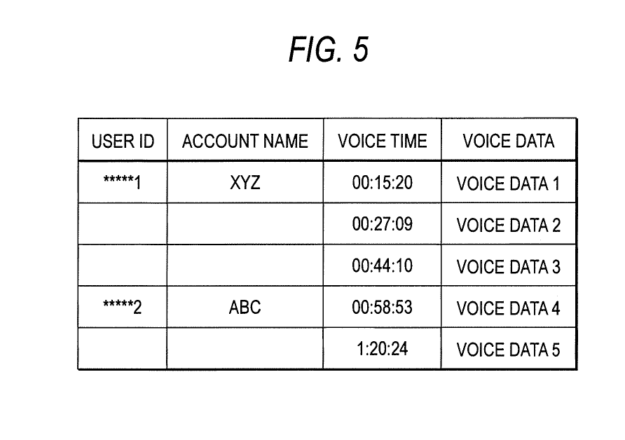

The user voice information 38 will be described below in more detail. FIG. 5 shows an exemplary detailed data structure of the user voice information 38 according to the embodiment.

Pieces of user voice information 38 of a motion picture content 25 are managed for respective users who input voices. Each piece of user voice information 38 consists of a user ID that is the identifier of a user who input voices, an account name that is a name the user having the user ID can set, voice times each of which is a time (an elapsed time from the start of playback of the motion picture) when a user voice was taken during the playback, and voice data of the user voices.

The DTV 1 according to the embodiment can receive a motion picture content 25 from the server 2 over the network 3 and play back the recorded program and the user voices of the received motion picture content 25. Components and functions of the DTV 1 that relate to such playback will be described below.

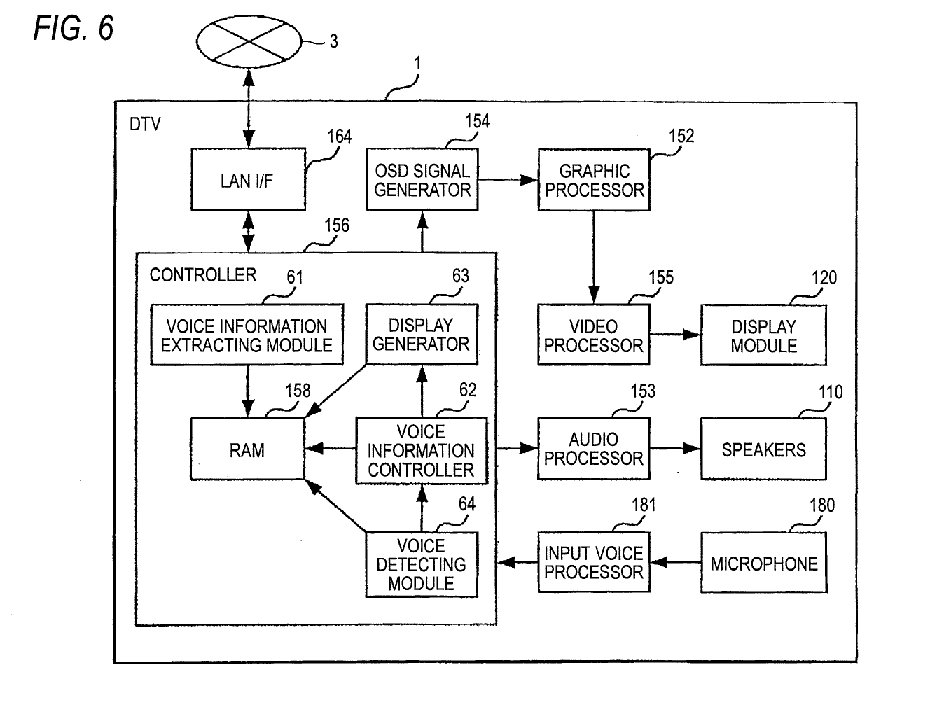

FIG. 6 is an exemplary block diagram showing a functional configuration, relating to a playback process for playing back the motion picture and the user voices of a motion picture content 25, of the DTV 1 according to the embodiment.

A voice information extracting module 61 has a function of extracting the pieces of user voice information 38 from the motion picture content 25 received from the server 2 over the network 3. The voice information extracting module 61 stores the extracted pieces of user voice information 38 in the RAM 158.

A voice information controller 62 has a function of controlling input/output of user voices. The voice information controller 62 measures the time from the start of playback of a recorded program. When the measured time reaches a voice time of a piece of user voice information 38, the voice information controller 62 outputs a corresponding user voice.

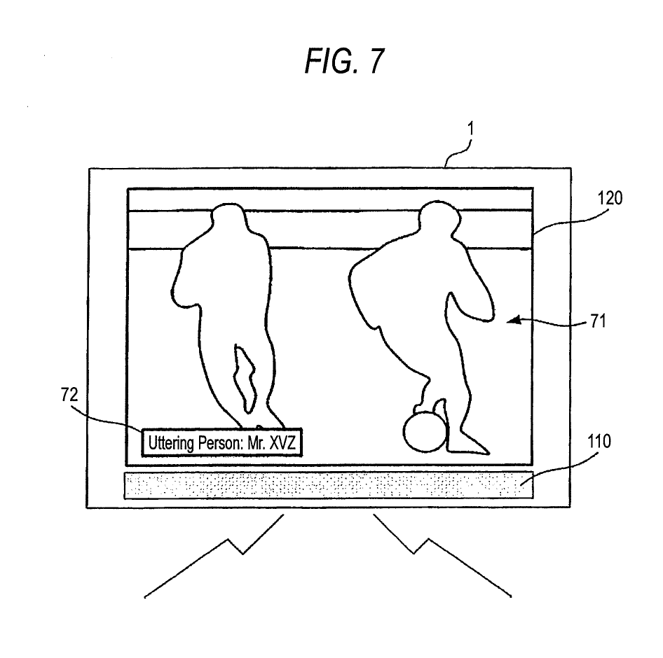

A display generator 63 has a function of generating a signal of an account name display image for display of the account name of the user who corresponds to a user voice when the voice information controller 62 outputs the user voice. The signal of the account name display image is output to the OSD signal generator 154 and the account name display image is displayed on the display module 120. The account name display image will further be described later with reference to FIG. 7.

A voice detecting module 64 has a function of detecting a voice that is input through the microphone 180 and whose volume level is higher than or equal to a prescribed value and storing data of the detected voice in the RAM 158. Alternatively, whether to store voice data in the RAM 158 may be judged without using the sound volume. For example, data of a voice that is input while the user is pressing a prescribed button of the remote controller 117 may be stored in the RAM 158. In this case, the user can transmit, to the server 2, intentionally, only user voices that the user wants to transmit to the server 2.

Next, the account name display image which is generated by the display generator 63 will be described.

FIG. 7 is a schematic view of the DTV 1 on which an account name display image is displayed according to the embodiment. As shown in FIG. 7, a motion picture 71 and an account name display image 72 are displayed on the display module 120 of the DTV 1. Reference numeral 110 denotes the speakers.

In an operation of playing back the motion picture 71 of a motion picture content received from the server 2, when the elapsed time from the start of the playback reaches a voice time of a pieces of user voice information 38, the DTV 1 outputs voice data that corresponds to the voice time from the speakers 110. At the same time, the DTV 1 displays the account name that is associated with the user voice on the display module 120 in such a manner it is included in the account name display image 72.

The user (viewer) who is watching the motion picture 71 can recognize the account name of a user who input the voice being output by looking at the account name display image 72. If not wanting to listen any more to user voices of the user who input the user voice being output, the viewer can prohibit output of the user voices of the user having the account name being displayed. If the viewer inputs a prohibition instruction to the DTV 1 using the remote controller 117 or the like, the voice information controller 62 will not output the voice data corresponding to this account name even if detecting those voice data in the RAM 158. In this manner, the viewer can make, according to the account name, a selection as to whether to output user voices.

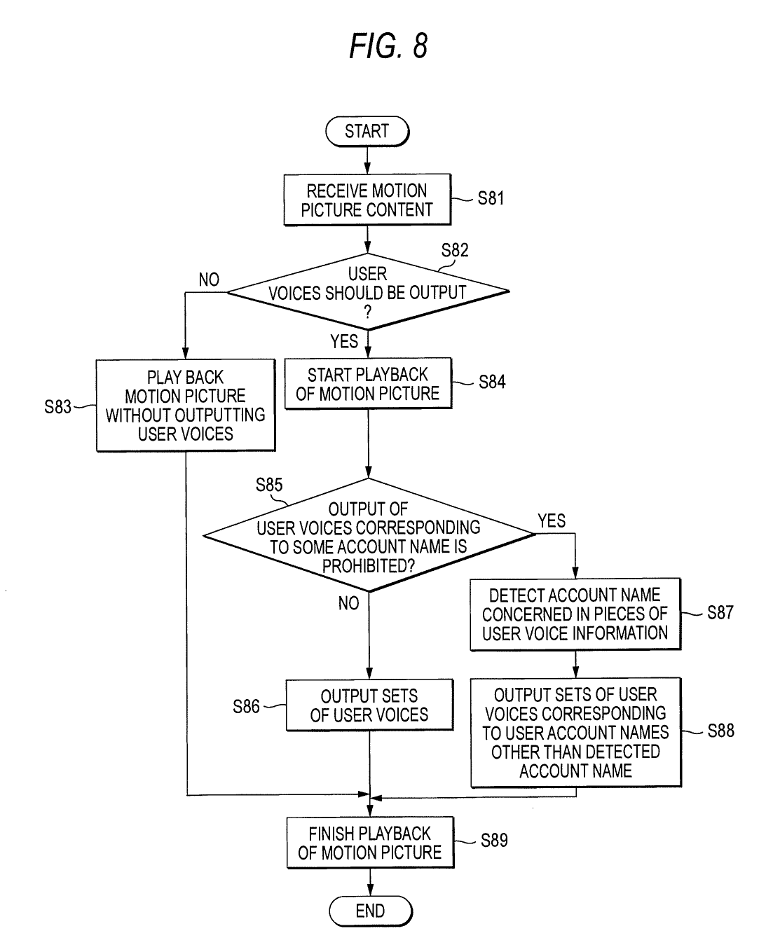

Next, the details of the process for playing back a motion picture content which is executed by the DTV 1 will be described. FIG. 8 is an exemplary flowchart of a process for playing back a motion picture content 25 which is executed by the DTV 1 according to the embodiment.

First, at step S81, the DTV 1 receives a motion picture content 25 from the server 2 over the network 3. At step S82, the DTV 1 judges whether or not a setting of outputting user voices is made. Whether to output user voices can be set by the user in advance using the remote controller 117 or the like.

If the setting of outputting user voices is not made (S82: no), at step S83 the DTV 1 only plays back a motion picture, that is, the voice controller 62 does not output user voices.

If the setting of outputting user voices is made (S82: yes), at step S84 the DTV 1 starts playback of a motion picture.

After executing step S84, at step S85 the voice controller 62 judges whether or not some account name is set as a voice output prohibition subject. A setting of prohibiting output of user voices of a particular account name can be made by the user in advance using the remote controller 117 or the like.

If no person is set as a voice output prohibition subject (S85: no), at step S86 the voice controller 62 outputs all sets of user voices that are stored in the RAM 158 so as to output each user voice when the elapsed time from the start of the playback has reached a corresponding voice time. At the same time, the display generator 63 causes the display module 120 to display an account name display image 72 including the account name corresponding to the user voice being output.

If some person is set as a voice output prohibition subject (S85: yes), at step S87 the voice controller 62 detects, in the pieces of user voice information 38, the account name that is set as a voice output prohibition subject. At step S88, the voice controller 62 outputs voice data other than the voice data corresponding to this account name so as to output each user voice when the elapsed time from the start of the playback has reached a corresponding voice time. In this case, the display generator 63 causes the display module 120 to display an account name display image 72 including the account name corresponding to the user voice being output.

When the playback of the motion picture is finished at step S89 after the execution of step S83, S86, or S88, the process is finished.

In the embodiment, the user can make a setting as to whether to output user voices, that is, can switch between a setting of outputting user voices and a setting of not outputting user voices. In the above process for playing back a motion picture content, whether to output user voices is set by the user before a start of playback of a program motion picture. A modification is possible in which whether to output user voices is set during playback of a motion picture and output of user voices is started or stopped according to this setting. Likewise, whether to output user voices corresponding to a particular account name may be set during playback of a motion picture.

In the embodiment, the DTV 1 can prohibit output of user voices of a particular user. This allows the user who views a motion picture to listen to only user voices he or she wants to do so.

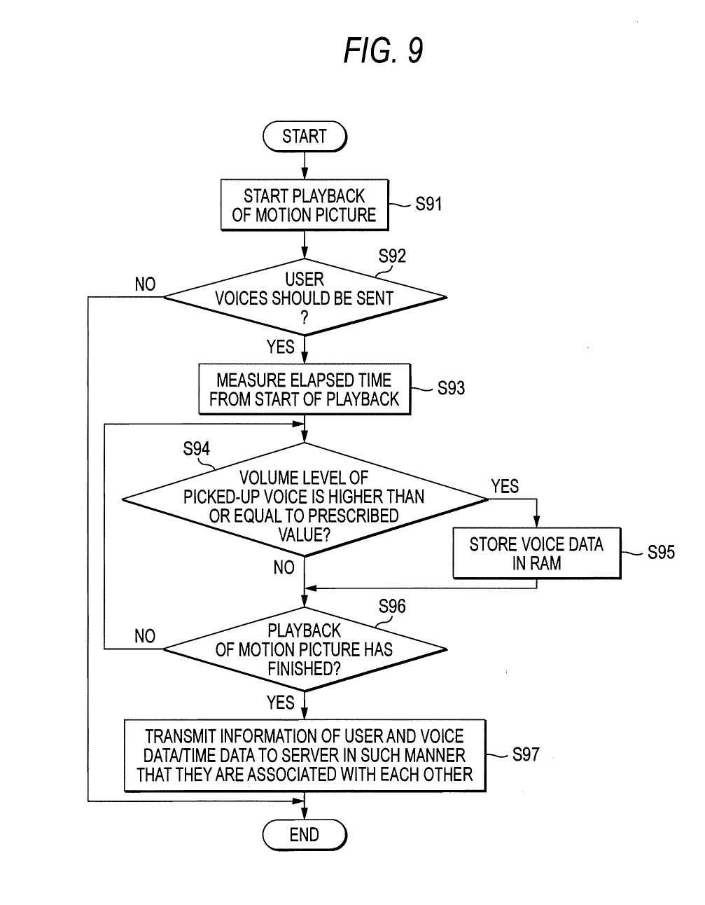

Next, a description will be made of a process for transmitting to the server 2 user voices that are taken by the DTV 1. FIG. 9 is an exemplary flowchart showing a process for transmitting to the server 2 user voices that are picked up by the DTV 1 according to the embodiment.

At step S91, the DTV 1 starts playback of the motion picture of a motion picture content 25. At step S92, the voice information controller 62 judges, on the basis of a setting, whether to transmit user voices to the server 2. This setting can also be made by the user in advance using the remote controller 117 or the like.

If user voices should be sent to the server 2 (S92: yes), at step S93 the voice information controller 62 measures the elapsed time from the start of playback of the program motion picture.

At step S94, the voice detecting module 64 judges whether or not the volume level of a voice that is picked up by the microphone 180 is higher than or equal to the prescribed value.

If the volume level of the picked-up voice is higher than or equal to the prescribed value (S94: yes), at step S95 the voice detecting module 62 stores this voice in the RAM 158. At the same time, the voice information controller 62 stores information of an elapsed time of this moment from the start of playback of the motion picture in the RAM 158 in such a manner that it is associated with voice data of this user voice.

If the volume level of the picked-up voice is lower than the prescribed value (S94: no), or when step S95 has been executed, steps S94 to S96 are executed repeatedly until it is judged at step S96 that the playback of the program motion picture has finished.

When the playback of the program motion picture has finished (S96: yes), at step S97 the voice information controller 62 transmits, to the server 2, the user ID and the account name of the user of the DTV 1 and voice data of user voices and elapsed times that are stored in the RAM 158 in such a manner that they are associated with each other.

The DTV 1 finishes the process when step S97 has been executed or if it is judged at step S92 that user voices should not be sent to the server 2.

The server 2 stores, as voice data of a motion picture content 25, user voices that are transmitted from an electronic apparatus such as the DTV 1. In transmitting this motion picture content 25 to another electronic apparatus, the server 2 transmits the user voices together with the motion picture.

While viewing a motion picture being played back, the user can listen to voices of another user who viewed this motion picture. The viewing of this motion picture using the DTV 1 would be very enjoyable to the user. For example, if a motion picture of a sporting event is played back while user voices of many users are output, the user could feel as if he or she were present in the place of the sporting event.

In playing back a motion picture, the DTV 1 (example electronic apparatus) according to the embodiment can output, simultaneously with the motion picture, voices that are independent of the motion picture and are provided by the server 2.

While certain embodiments have been described, these embodiments have been presented by way of example only, and are not intended to limit the scope of the invention. Indeed, the novel apparatus, system and method described herein may be embodied in a variety of other forms; furthermore, various omissions, substitutions and changes in the form of the apparatus, system and the method described herein may be made without departing from the sprit of the invention. The accompanying claims and their equivalents are intended to cover such forms or modifications as would fall within the scope and sprit of the invention.

What is claimed is:

1. An electronic apparatus comprising:
a receiving module configured to receive data of a motion picture and data of sound associated with a given timing in the motion picture, the data of the sound generated separately from the motion picture;
a motion picture playing back module configured to play back the motion picture; and
a sound output module configured to output the sound at the given timing when the motion picture playing back module plays back the motion picture.

2. The apparatus of claim 1 further comprising:
an image display module configured to display a display image,
wherein the receiving module is configured to receive text data corresponding to the sound, and
wherein the image display module displays the display image based on the text data corresponding to the sound when the sound output module outputs the sound.

3. The apparatus of claim 1 further comprising:
a sound picking-up module configured to pick up ambient sound while the motion picture playing back module is playing back the motion picture,
wherein the sound comprises the ambient sound.

4. The apparatus of claim 3 further comprising:
a transmitting module configured to transmit data of the ambient sound associated with information of the motion picture.

5. The apparatus of claim 1 wherein the sound output module comprises a switching module configured to switch between output and non-output of the sound, and the sound output module is configured to output the sound according to the switching by the switching module.

6. A motion picture playback system comprising:
a server comprising
a storage configured to store data of a motion picture and data of sound associated with a given timing in the motion picture, the data of the sound generated separately from the motion picture; and
a transmitting module configured to transmit the data of the motion picture and the data of the sound stored in the storage; and
an electronic apparatus comprising
a receiving module configured to receive the data of the motion picture and the data of the sound from the server;
a motion picture playing back module configured to play back the motion picture; and
a sound output module configured to output the sound at the given timing when the motion picture playing back module plays back the motion picture.

7. The system of claim 6 wherein the electronic apparatus further comprises a sound picking-up module configured to pick up ambient sound while the motion picture playing back module is playing back the motion picture; and a transmitting module configured to transmit, to the server, data of the ambient sound associated with information of the motion picture; and
wherein the storage stores the data of the ambient sound as the data of the sound that is associated with the information of the motion picture.

8. A motion picture playback method comprising:
receiving data of a motion picture and data of sound associated with a given timing in the motion picture, the data of the sound generated separately from the motion picture; and
outputting the sound at the given timing when the motion picture plays back.
